(19) United States
(12) Patent Application Publication
(10) Pub. No.: US 2026/0010968 A1
(43) Pub. Date: Jan. 8, 2026

(54) CONCURRENT TEXTURE FETCH USING GRAPHICS MEMORY

(71) Applicant: QUALCOMM Incorporated, San Diego, CA (US)

(72) Inventors: Nawneet KUMAR, Bangalore (IN); Sanjeevi S, Bangalore (IN); Rakshit JOSHI, Almora (IN); Avinash JAIN, Ghaziabad (IN)

(21) Appl. No.: 18/764,097

(22) Filed: Jul. 3, 2024

(51) Int. Cl. G06T 1/20; G06T 1/60

(52) U.S. Cl. CPC G06T 1/20; G06T 1/60

(57) ABSTRACT

Aspects presented herein relate to methods and devices for graphics processing including an apparatus, e.g., a graphics processor. The apparatus may obtain an indication of a set of graphics workloads associated with the graphics processing. The apparatus may also execute a first graphics workload in the set of graphics workloads, where the first graphics workload is associated with first data. Further, the apparatus may store, based on the execution of the first graphics workload, second data that is associated with a second graphics workload in the set of graphics workloads.

### TECHNICAL FIELD

The present disclosure relates generally to processing systems and, more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor or display processing unit (DPU).

A graphics processor of a device may be configured to perform the processes in a graphics processing pipeline. Further, graphics processors may be utilized to store and retrieve data. However, there has developed an increased need for improved storage and retrieval of data in graphics processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processor, a graphics processing unit (GPU), a central processing unit (CPU), or any apparatus that may perform for graphics processing. The apparatus may obtain an indication of a set of graphics workloads associated with the graphics processing. The apparatus may also store the first data associated with the at least one first graphics workload in the set of graphics workloads; and retrieve, prior to the execution of the at least one first graphics workload, the first data associated with the at least one first graphics workload. The apparatus may also execute at least one first graphics workload in the set of graphics workloads, where the at least one first graphics workload is associated with first data. Additionally, the apparatus may output, prior to storage of second data, an indication to store the second data that is associated with the at least one second graphics workload. The apparatus may also store, based on the execution of the at least one first graphics workload, second data that is associated with at least one second graphics workload in the set of graphics workloads. Moreover, the apparatus may determine whether a storage capacity of memory at a graphics processor is less than or equal to a storage threshold. The apparatus may also store, in the memory based on the storage capacity of the memory being less than the storage threshold, third data that is associated with at least one third graphics workload in the set of graphics workloads. The apparatus may also discard, from the memory based on the storage capacity of the memory being equal to the storage threshold, previous data that is associated with at least one previous graphics workload; and store, in the memory, third data that is associated with at least one third graphics workload in the set of graphics workloads. Further, the apparatus may retrieve, after storage of the second data, the second data that is associated with the at least one second graphics workload; and output, based on the retrieval, the second data that is associated with the at least one second graphics workload. The apparatus may also output an indication of storage of the second data that is associated with the at least one second graphics workload.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system in accordance with one or more techniques of this disclosure.

FIG. 2 illustrates an example graphics processing unit (GPU) in accordance with one or more techniques of this disclosure.

FIG. 3 is a diagram illustrating example processing components in accordance with one or more techniques of this disclosure.

FIG. 4 is a diagram illustrating an example image or surface in accordance with one or more techniques of this disclosure.

FIG. 5 is a diagram illustrating an example geometry pipeline in accordance with one or more techniques of this disclosure.

FIG. 6 is a diagram illustrating an example GPU hardware in accordance with one or more techniques of this disclosure.

FIG. 7 is a diagram illustrating an example execution sequence in accordance with one or more techniques of this disclosure.

FIG. 8 is a diagram illustrating an example workload processing sequence in accordance with one or more techniques of this disclosure.

FIG. 9 is a diagram illustrating an example workload processing sequence in accordance with one or more techniques of this disclosure.

FIG. 10 is a communication flow diagram illustrating example communications between a GPU, a CPU/GPU, and a memory in accordance with one or more techniques of this disclosure.

FIG. 11 is a flowchart of an example method of graphics processing in accordance with one or more techniques of this disclosure.

FIG. 12 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended. In some examples, as used herein, the term “graphics workload” may refer to any workload or order associated with graphics processing. In some examples, as used herein, the term “texture fetch” may refer to a memory request, which incurs transactions from a cache (e.g., a texture cache). Each time a warp executes a texture function to read from texture memory, this may be a single texture fetch. Also, texture memory may be read-only device memory, and may be accessed using the device functions described in a texture function. Reading a texture using one of these functions may be called a “texture fetch.”

In some aspects of graphics processing, the computational power utilized within graphics processing has increased significantly. For instance, the computational power of graphics processors and GPUs has increased. However, certain aspects of graphics processing remain a bottleneck or limitation within graphics processors and GPUs. For example, certain benchmarks (e.g., three-dimensional 3D benchmarks) within certain applications and games may be limited by the memory bandwidth at graphics processors (e.g., the bandwidth of double data rate (DDR) memory). That is, despite the increase in computational power, certain games and benchmarks may be limited by the memory bandwidth of graphics processors and GPU (e.g., the DDR). Indeed, another bottleneck or limitation for applications in graphics processing is the compute latency at graphics processors (i.e., the time taken to perform the actual computations at graphics processors). Additionally, texture fetch latency (i.e., the time taken to perform texture fetch operations) remains a bottleneck or limitation within graphics processing. Also, texture fetch latency (i.e., the time taken to perform texture fetch operations) remains a bottleneck or limitation within graphics processing. Indeed, the texture fetch latency is a bottleneck or limitation at graphics processors for certain applications and games (e.g., three-dimensional (3D) games). Although there has been a lot of advancement to increase the processing speed at graphics processors, little has been done in order to reduce the time taken texture fetching operations. In some aspects, textures may be fetched at a graphics processor after the shader processor (SP) reads the instructions to fetch. For example, the shader processor may first check which textures need to be fetched and then a command is used to bring in the textures from the internal memory. Over time, several techniques have been designed to optimize the bandwidth utilization for the generation of textures in graphics processors, as well as for other operations such as block compression, etc. However, bandwidth utilization for the generation of textures still remains an issue within graphics processing. Aspects presented herein may allow for an increase in the memory bandwidth of graphics processors and GPUs.

Aspects of the present disclosure may include a number of benefits or advantages. For instance, aspects presented herein may allow for an increase in the memory bandwidth of graphics processors and GPUs. That is, aspects presented herein may increase the memory bandwidth at graphics processors and GPUs in order to allow for an increase in computational power at graphics processors and GPUs. Further, aspects presented herein may reduce or optimize the amount of time taken during texture fetch operations at graphics processors and GPUs. For instance, aspects presented herein may parallelize execution of texture fetch operations by making these operations concurrent with the execution of the other operations at graphics processors. Indeed, aspects presented herein may allow for texture fetch operations to be performed in parallel with other operations. By doing so, aspects presented herein may reduce the amount of latency that is associated with texture fetch operations.

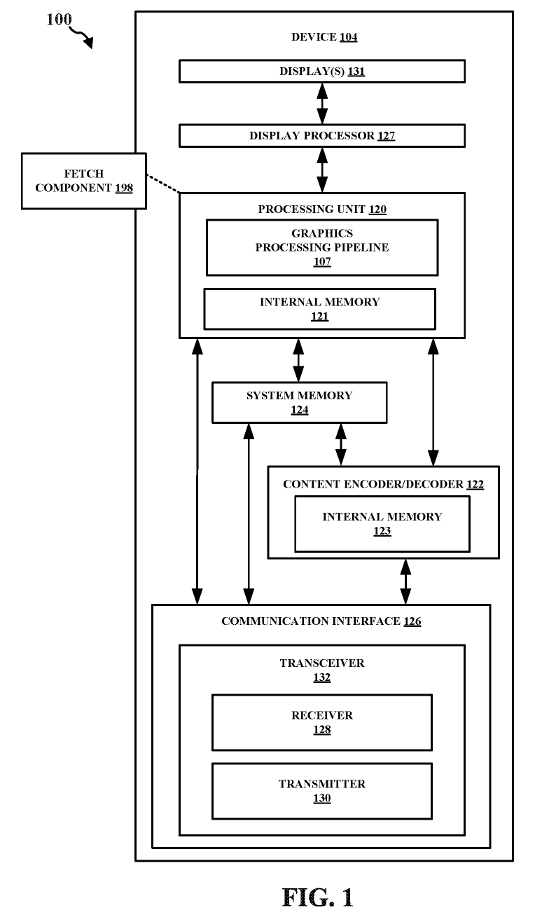

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a fetch component 198 configured to obtain an indication of a set of graphics workloads associated with the graphics processing. The fetch component 198 may also be configured to store the first data associated with the at least one first graphics workload in the set of graphics workloads; and retrieve, prior to the execution of the at least one first graphics workload, the first data associated with the at least one first graphics workload. The fetch component 198 may also be configured to execute at least one first graphics workload in the set of graphics workloads, where the at least one first graphics workload is associated with first data. The fetch component 198 may also be configured to output, prior to storage of second data, an indication to store the second data that is associated with the at least one second graphics workload. The fetch component 198 may also be configured to store, based on the execution of the at least one first graphics workload, second data that is associated with at least one second graphics workload in the set of graphics workloads. The fetch component 198 may also be configured to determine whether a storage capacity of memory at a graphics processor is less than or equal to a storage threshold. The fetch component 198 may also be configured to store, in the memory based on the storage capacity of the memory being less than the storage threshold, third data that is associated with at least one third graphics workload in the set of graphics workloads. The fetch component 198 may also be configured to discard, from the memory based on the storage capacity of the memory being equal to the storage threshold, previous data that is associated with at least one previous graphics workload; and store, in the memory, third data that is associated with at least one third graphics workload in the set of graphics workloads. The fetch component 198 may also be configured to retrieve, after storage of the second data, the second data that is associated with the at least one second graphics workload; and output, based on the retrieval, the second data that is associated with the at least one second graphics workload. The fetch component 198 may also be configured to output an indication of storage of the second data that is associated with the at least one second graphics workload. Although the following description may be focused on display processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

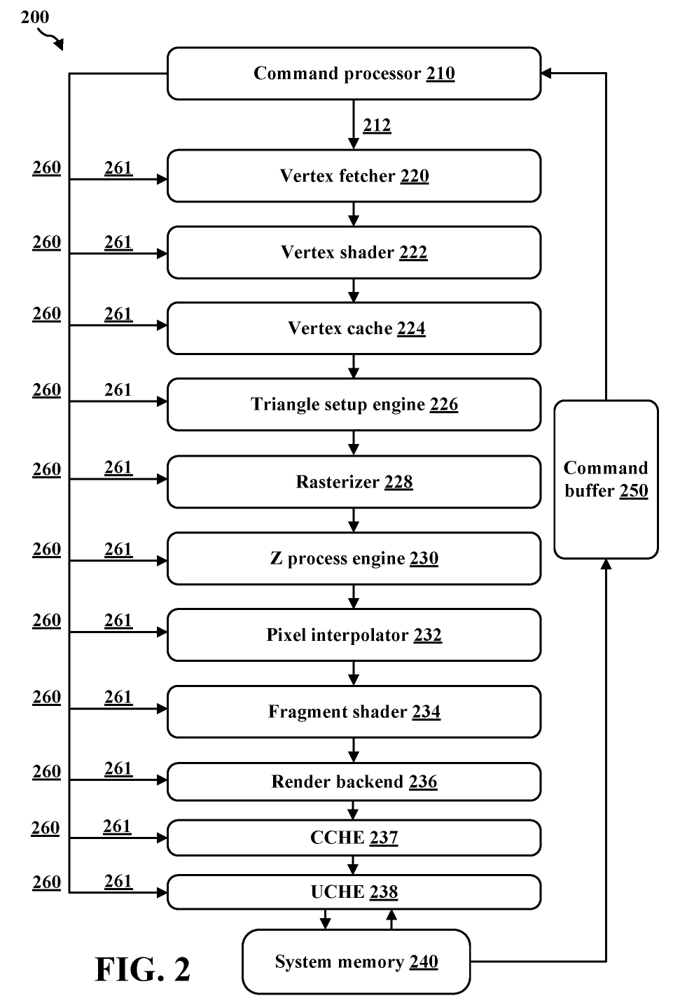

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 1 (L1) cache (cluster cache (CCHE)) 237, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in double data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some types of GPUs may include different types of pipelines, such as a graphics processing pipeline. Graphics processing pipelines may include one or more of a vertex shader stage, a hull shader stage, a domain shader stage, a geometry shader stage, and a pixel shader stage. These stages of the graphics processing pipeline may be considered shader stages. These shader stages may be implemented as one or more shader programs that execute on shader units at a GPU. Shader units may be configured as a programmable pipeline of processing components. In some examples, a shader unit may be referred to as “shader processors” or “unified shaders,” and may perform geometry, vertex, pixel, or other shading operations to render graphics. Shader units may include shader processors, each of which may include one or more components for fetching and decoding operations, one or more arithmetic logic units (ALUs) for carrying out arithmetic calculations, one or more memories, caches, and registers.

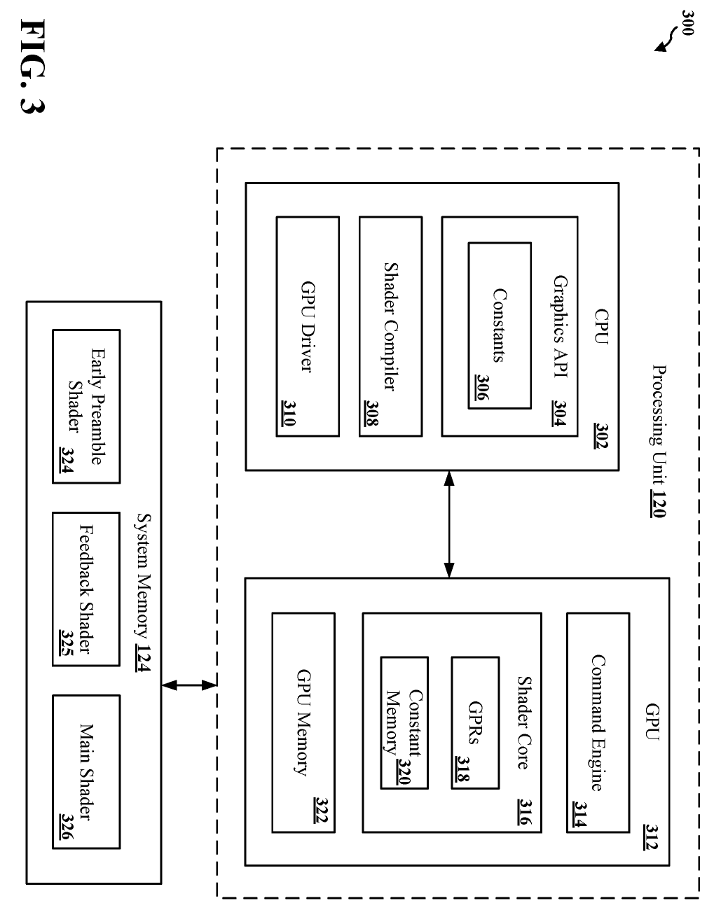

FIG. 3 is a diagram 300 that illustrates processing components, such as the processing unit 120 and the system memory 124, as may be identified in connection with the device 104 for processing data. In aspects, the processing unit 120 may include a CPU 302 and a GPU 312. The GPU 312 and the CPU 302 may be formed as an integrated circuit (e.g., a system-on-a-chip (SOC)) and/or the GPU 312 may be incorporated onto a motherboard with the CPU 302. Alternatively, the CPU 302 and the GPU 312 may be configured as distinct processing units that are communicatively coupled to each other. For example, the GPU 312 may be incorporated on a graphics card that is installed in a port of the motherboard that includes the CPU 302.

The CPU 302 may be configured to execute a software application that causes graphical content to be displayed (e.g., on the display(s) 131 of the device 104) based on one or more operations of the GPU 312. The software application may issue instructions to a graphics application program interface (API) 304, which may be a runtime program that translates instructions received from the software application into a format that is readable by a GPU driver 310. After receiving instructions from the software application via the graphics API 304, the GPU driver 310 may control an operation of the GPU 312 based on the instructions. For example, the GPU driver 310 may generate one or more command streams that are placed into the system memory 124, where the GPU 312 is instructed to execute the command streams (e.g., via one or more system calls). A command engine 314 included in the GPU 312 is configured to retrieve the one or more commands stored in the command streams. The command engine 314 may provide commands from the command stream for execution by the GPU 312. The command engine 314 may be hardware of the GPU 312, software/firmware executing on the GPU 312, or a combination thereof. While the GPU driver 310 is configured to implement the graphics API 304, the GPU driver 310 is not limited to being configured in accordance with any particular API. The system memory 124 may store the code for the GPU driver 310, which the CPU 302 may retrieve for execution. In examples, the GPU driver 310 may be configured to allow communication between the CPU 302 and the GPU 312, such as when the CPU 302 offloads graphics or non-graphics processing tasks to the GPU 312 via the GPU driver 310.

The system memory 124 may further store source code for one or more of an early preamble shader 324, a feedback shader 325, or a main shader 326. In such configurations, a shader compiler 308 executing on the CPU 302 may compile the source code of the shaders 324-326 to create object code or intermediate code executable by a shader core 316 of the GPU 312 during runtime (e.g., at the time when the shaders 324-326 are to be executed on the shader core 316). In some examples, the shader compiler 308 may pre-compile the shaders 324-326 and store the object code or intermediate code of the shader programs in the system memory 124. The shader compiler 308 (or in another example the GPU driver 310) executing on the CPU 302 may build a shader program with multiple components including the early preamble shader 324, the feedback shader 325, and the main shader 326. The main shader 326 may correspond to a portion or the entirety of the shader program that does not include the early preamble shader 324 or the feedback shader 325. The shader compiler 308 may receive instructions to compile the shader(s) 324-326 from a program executing on the CPU 302. The shader compiler 308 may also identify constant load instructions and common operations in the shader program for including the common operations within the early preamble shader 324 (rather than the main shader 326). The shader compiler 308 may identify such common instructions, for example, based on (presently undetermined) constants 306 to be included in the common instructions. The constants 306 may be defined within the graphics API 304 to be constant across an entire draw call. The shader compiler 308 may utilize instructions such as a preamble shader start to indicate a beginning of the early preamble shader 324 and a preamble shader end to indicate an end of the early preamble shader 324. Similar instructions may be used for the feedback shader 325 and the main shader 326. The feedback shader 325 will be described in further detail below.

The shader core 316 included in the GPU 312 may include general purpose registers (GPRs) 318 and constant memory 320. The GPRs 318 may correspond to a single GPR, a GPR file, and/or a GPR bank. Each GPR in the GPRs 318 may store data accessible to a single thread. The software and/or firmware executing on GPU 312 may be a shader program 324-326, which may execute on the shader core 316 of GPU 312. The shader core 316 may be configured to execute many instances of the same instructions of the same shader program in parallel. For example, the shader core 316 may execute the main shader 326 for each pixel that defines a given shape. The shader core 316 may transmit and receive data from applications executing on the CPU 302. In examples, constants 306 used for execution of the shaders 324-326 may be stored in a constant memory 320 (e.g., a read/write constant RAM) or the GPRs 318. The shader core 316 may load the constants 306 into the constant memory 320. In further examples, execution of the early preamble shader 324 or the feedback shader 325 may cause a constant value or a set of constant values to be stored in on-chip memory such as the constant memory 320 (e.g., constant RAM), the GPU memory 322, or the system memory 124. The constant memory 320 may include memory accessible by all aspects of the shader core 316 rather than just a particular portion reserved for a particular thread such as values held in the GPRs 318.

GPUs can render images in a variety of different ways. In some instances, GPUs can render an image using rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects, during a binning pass, an image can be divided into different bins or tiles. In some aspects, during the binning pass, a visibility stream can be constructed where visible primitives or draw calls can be identified. In contrast to tiled rendering, direct rendering does not divide the frame into smaller bins or tiles. Rather, in direct rendering, the entire frame is rendered at a single time. Additionally, some types of GPUs can allow for both tiled rendering and direct rendering.

In some aspects, GPUs can apply the drawing or rendering process to different bins or tiles. For instance, a GPU can render to one bin, and perform all the draws for the primitives or pixels in the bin. During the process of rendering to a bin, the render targets can be located in the GMEM. In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory used to drop primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

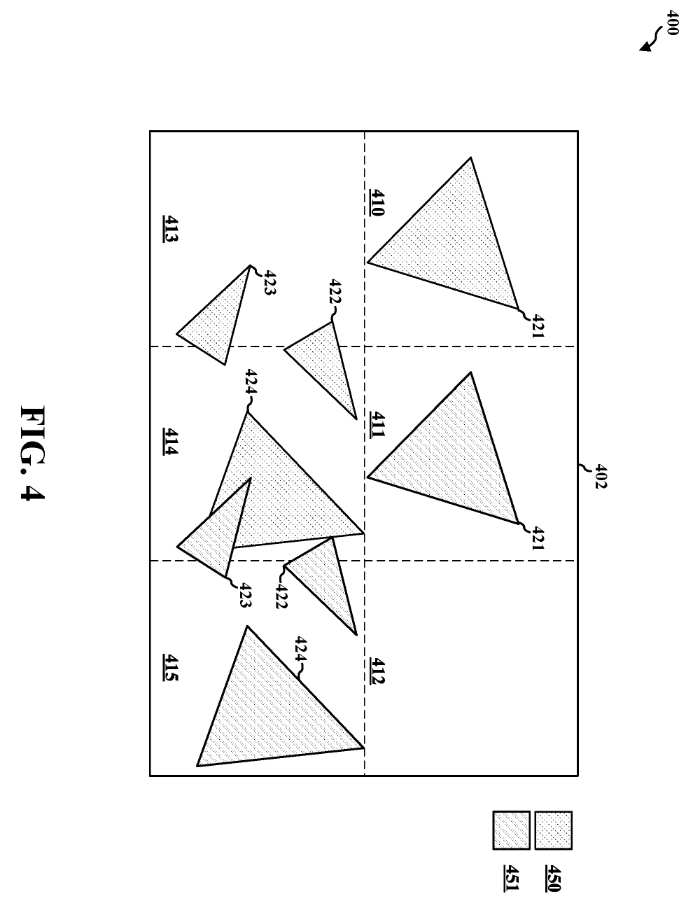

FIG. 4 illustrates image or surface 400, including multiple primitives divided into multiple bins. As shown in FIG. 4, image or surface 400 includes area 402, which includes primitives 421, 422, 423, and 424. The primitives 421, 422, 423, and 424 are divided or placed into different bins, e.g., bins 410, 411, 412, 413, 414, and 415. FIG. 4 illustrates an example of tiled rendering using multiple viewpoints for the primitives 421-424. For instance, primitives 421-424 are in first viewpoint 450 and second viewpoint 451. As such, the GPU processing or rendering the image or surface 400 including area 402 can utilize multiple viewpoints or multi-view rendering.

As indicated herein, GPUs or graphics processor units can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

In some aspects of graphics processing, GPU hardware may be divided into multiple sections, e.g., hardware for geometry processing and hardware for pixel processing. Scalable GPU hardware may be desirable in order to meet different throughputs across various market segments. Also, in some aspects, scalable hardware for pixel processing may be designed in a variety of ways. For instance, a screen may be divided into different parts and multiple pixel processing hardware modules (i.e., slices) may work independently on different parts of the screen. By changing the number of pixel slices, a scalable throughput may be achieved for different tiers. However, designing scalable geometry processing hardware has an inherent challenge of evenly distributing the workload across independently working hardware modules (i.e., geometry slices).

There are a number of issues that may be encountered when designing scalable geometry processing hardware. For instance, the variable size of a drawcall (i.e., a work unit) and an adaptive workload expansion in the middle of the geometry pipeline are some issues that may occur when designing scalable geometry processing hardware. Workloads across different drawcalls may vary, so tying each drawcall to a geometry slice may create uneven data downstream. Apart from this, an application program interface (API) may specify that a geometry pipeline may support adaptive workload expansion/reduction through different features, e.g., tessellation, geometry shading, and/or triangle culling.

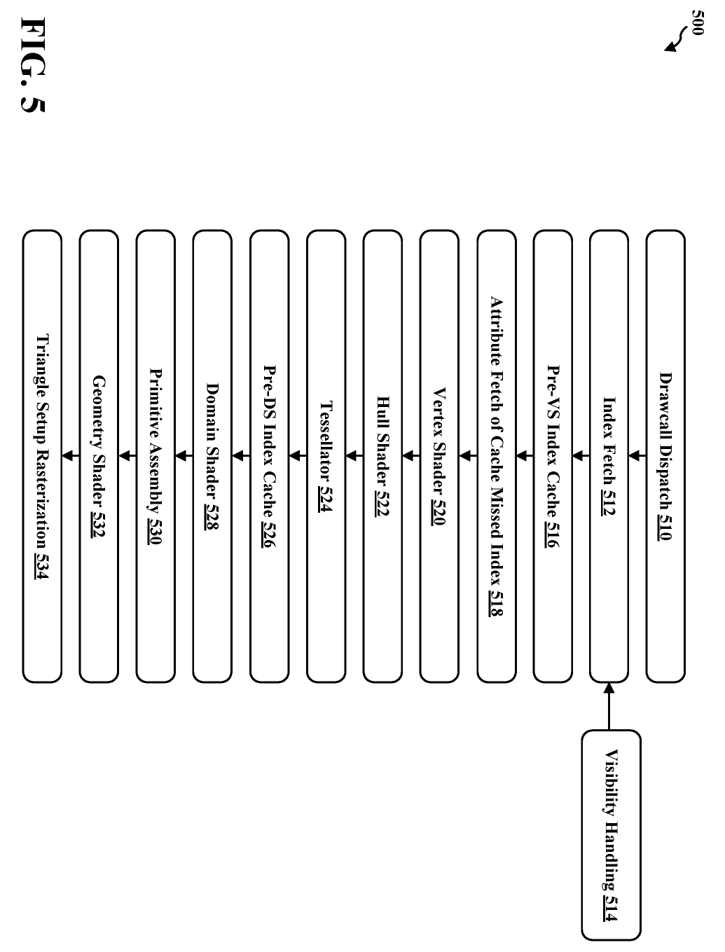

FIG. 5 is a diagram 500 illustrating an example geometry pipeline in a GPU. As depicted in FIG. 5, diagram 500 includes a drawcall dispatch 510, an index fetch 512, a visibility handling step 514, a pre-vertex shader index cache 516, an attribute fetch of a cache missed index 518, a vertex shader 520, a hull shader 522, a tessellator 524, a pre-domain shader index cache 526, a domain shader 528, a primitive assembly 530, a geometry shader 532, and a triangle setup rasterization 534. As shown in FIG. 5, after an index fetch 512, each primitive may be expanded to create multiple primitives, where an amplification factor may be determined during run-time. As such, sending primitives to different modules without considering an amplification factor may create an unequal workload in a downstream pipeline. Accordingly, this may prevent the achievement of an optimal throughput.

Another issue that may be encountered when designing scalable geometry processing hardware is visibility handling (e.g., tiled rendering) across multiple geometry slices. As indicated above, in tile-based rendering, the screen is divided into multiple bins, and a binning pass is used to generate a per-bin visibility stream (i.e., primitives that may be identified as visible in a bin). Also, the visibility stream may be used in multiple bin-rendering passes (e.g., dropping invisible primitives from processing) to render the whole screen. Because of different visibilities of primitives, the workload pattern in each bin-rendering pass may vary significantly from a binning pass. A workload distribution scheme may need to ensure that an even workload (including amplification) is distributed to each geometry slice (even when accounting for the potential disparity in visibility).

In some aspects, different types of GPU hardware may support different types of workload execution. Additionally, different types of workloads may take a different amount of processing time in various stages of the GPU pipeline. Also, these types of workloads may introduce inefficiency in GPU hardware utilization. In some aspects, scheduling algorithms in order to time-share the GPU hardware may sequence the workload to achieve the best utilization of GPU hardware. This kind of workload pattern is common in certain types of binning (e.g., concurrent binning). For example, in concurrent binning, a tile sorting pass for a certain frame (e.g., frame ‘N+1’) may be run concurrently with a rendering pass of another frame (e.g., frame ‘N’).

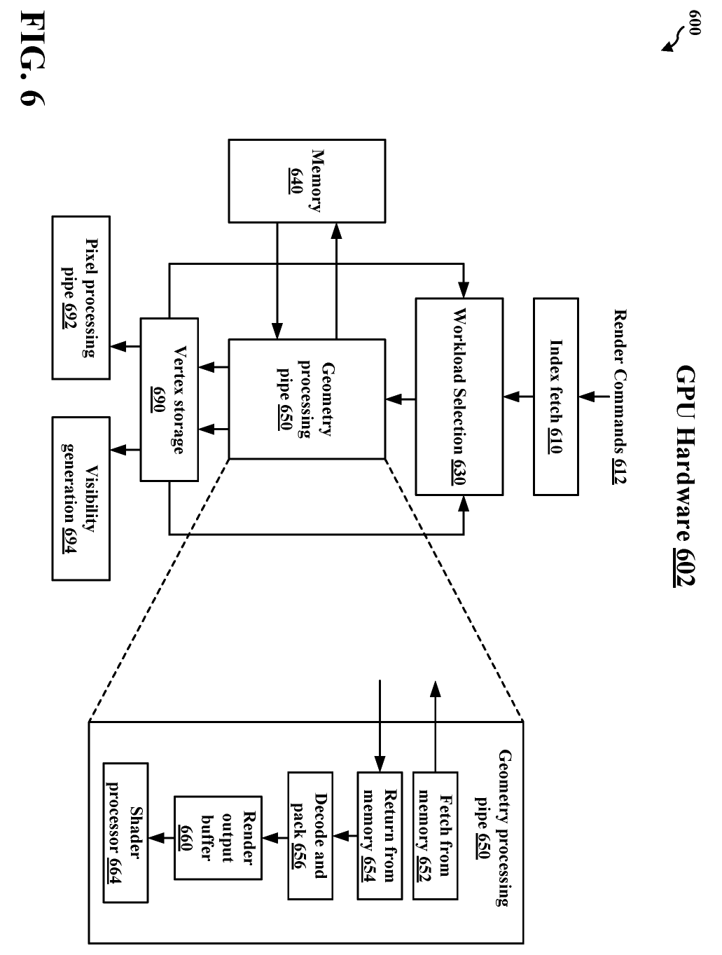

FIG. 6 illustrates diagram 600 including one example of GPU hardware. More specifically, diagram 600 depicts a time-shared GPU hardware for concurrent binning. As shown in FIG. 6, diagram 600 includes GPU hardware 602 including index fetch component 610, workload selection component 630, memory 640, geometry processing pipe 650, vertex storage component 690, pixel processing pipe 692, and visibility generation component 694. As shown in FIG. 6, render commands 612 may be input to index fetch component 610, which may be output to workload selection component 630. The workload selection component 630 may have a render/sort selection capability, as well as a certain granularity (e.g., a granularity for a group of N primitives). Also, the workload selection component 630 may be referred to as a workload selection switch component, switch component, workload selection component, or selection component. The “switch” may refers to a switch in the selection of render/sorting workloads. The output of workload selection component 630 may be sent to geometry processing pipe 650, which may communicate with memory 640. The geometry processing pipe 650 may include fetch from memory component 652, return from memory component 654, decode and pack component 656, render output buffer 660, and shader processor 664. Also, the output of geometry processing pipe 650 may be sent to vertex storage component 690, which may be sent to pixel processing pipe 692 and visibility generation component 694.

As shown in FIG. 6, geometry pipe hardware (e.g., geometry processing pipe 650) may be time shared between tile sorting and tile render workloads. Also, a scheduling algorithm (e.g., workload selection component 630) may consider the availability of GPU hardware for tile sorting and tile render workload. The granularity of a workload may be selected such that there is limited workload switching overhead. Further, the granularity of a workload may be selected such that, at the same time, one workload does not block the other. As shown in FIG. 6, the workload selection component 630 may have a granularity of a group of N primitives. For instance, for concurrent binning, the workload distribution granularity may be a primitive batch (e.g., a set of N primitives).

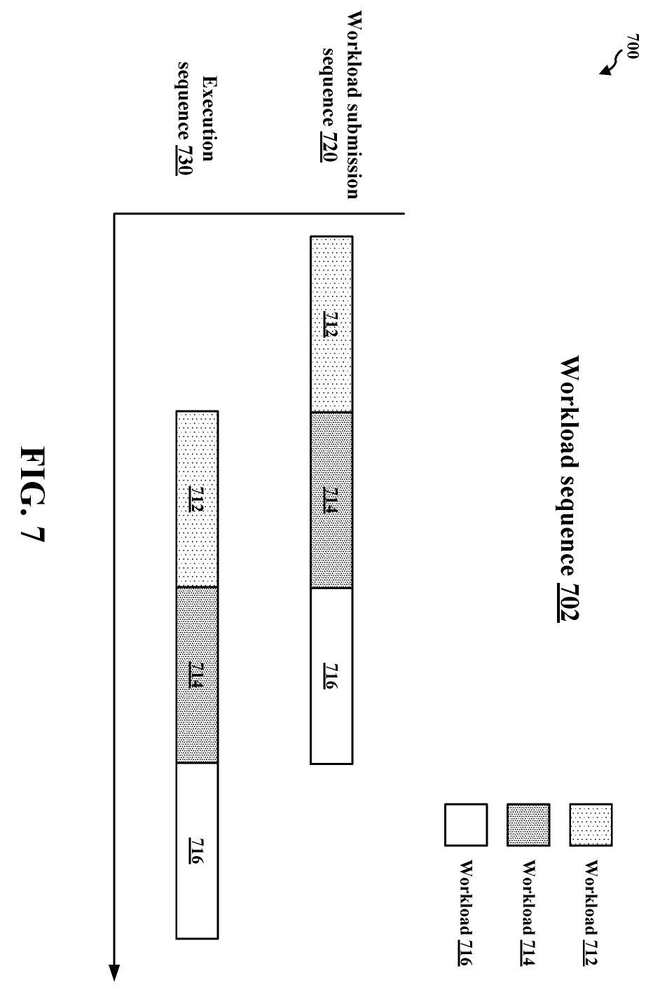

Certain types of workloads (e.g., sorting workloads) may face higher memory access latencies compared to other types of workloads (e.g., render workloads). For example, render workloads may be of higher priority than sorting workloads, which may face higher memory access latencies. In some aspects, if these types of workloads (e.g., sorting workloads) are executed in-order as per the scheduled workload sequence and granularity, there may be a reduction in hardware efficiency. For instance, if these types of workloads (e.g., sorting workloads) are executed in-order as per the scheduled workload sequence and granularity, a certain workload block (e.g., a head-of-line block) may occur, thus reducing the hardware efficiency. This type of scenario is shown in FIG. 7.

FIG. 7 illustrates diagram 700 including one example of a workload execution sequence. More specifically, diagram 700 depicts a workload execution sequence for a GPU (i.e., a scheduled execution order). As shown in FIG. 7, diagram 700 includes workload sequence 702 including workload 712, workload 714, workload 716, workload submission sequence 720, and execution sequence 730. FIG. 7 depicts a timeline of workload execution including workload submission sequence 720 and execution sequence 730. FIG. 7 illustrates that certain types of workloads (e.g., workload 712, workload 714, and workload 716) are executed in a certain order as per the scheduled workload sequence. As shown in FIG. 7, consider a workload submission sequence 720 (e.g., as determined by the workload selection component 630 in FIG. 6) to be workload 712, workload 714, and workload 716. Each of these workload may need to fetch data from memory (e.g., memory 640) and send it to shader processor (e.g., shader processor 664) for further processing. In some aspects, there may be a limit on how many requests can be made without processing the returned data (e.g., an OT limit). In some instances, some of the memory accesses for workload 714 may be granted before all accesses for workload 712, and some of the memory accesses for workload 716 may be granted before all accesses for workload 714.

In some aspects of graphics processing, the computational power utilized within graphics processing has increased significantly. For instance, the computational power of graphics processors and GPUs has increased. However, certain aspects of graphics processing remain a bottleneck or limitation within graphics processors and GPUs. For example, certain benchmarks (e.g., three-dimensional 3D benchmarks) within certain applications and games may be limited by the memory bandwidth at graphics processors (e.g., the bandwidth of DDR memory). That is, despite the increase in computational power, certain games and benchmarks may be limited by the memory bandwidth of graphics processors and GPU (e.g., the DDR). Indeed, another bottleneck or limitation for applications in graphics processing is the compute latency at graphics processors (i.e., the time taken to perform the actual computations at graphics processors). Additionally, texture fetch latency (i.e., the time taken to perform texture fetch operations) remains a bottleneck or limitation within graphics processing.

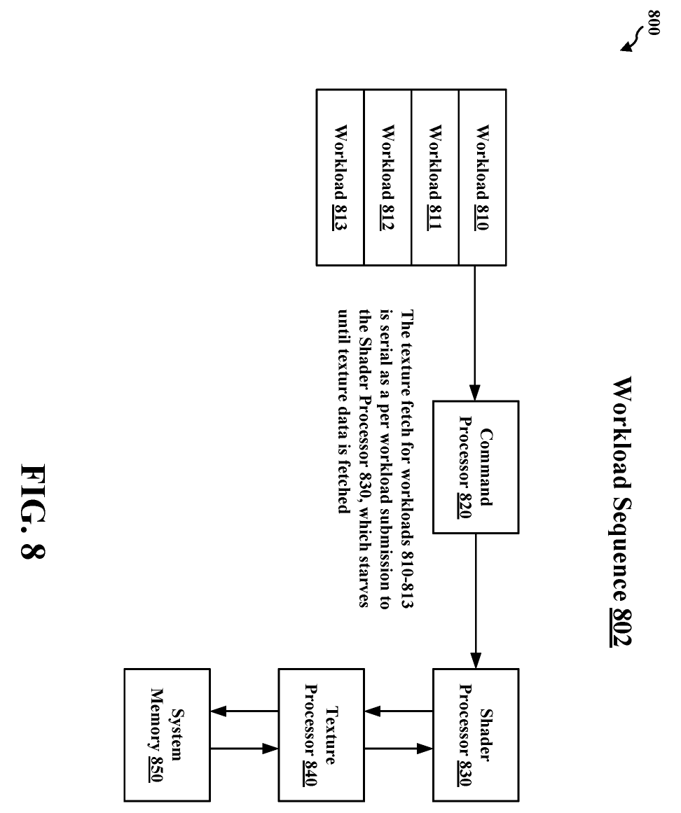

FIG. 8 illustrates diagram 800 including one example of a workload processing sequence. More specifically, diagram 800 depicts a workload execution and texture fetch sequence for graphics processors. As shown in FIG. 8, diagram 800 depicts a workload sequence 802 including a number of workloads (e.g., workload 810, workload 811, workload 812, and workload 813), a command processor 820, a shader processor 830, a texture processor 840, and system memory 850. FIG. 8 shows that texture fetch operation for each of the workloads (e.g., workload 810, workload 811, workload 812, and workload 813) may be performed in serial. Accordingly, the texture fetch operation may not be performed at the same time as other operations, which may result in a high latency for all operations. That is, the texture fetch for each of the workloads (e.g., workload 810, workload 811, workload 812, and workload 813) may be serial as a per-workload submission to the shader processor 830. The shader processor 830 may then be idle (i.e., starves) until the texture data is fetched. Indeed, the texture fetch may be sent to command processor 820 and then sent to shader processor 830 in a serial fashion. As noted in FIG. 8, the shader processor 830 may communicate with the texture processor 840, and the texture processor 840 may communicate with the system memory 850.

As shown in FIG. 8, texture fetch latency (i.e., the time taken to perform texture fetch operations) remains a bottleneck or limitation within graphics processing. Indeed, the texture fetch latency is a bottleneck or limitation at graphics processors for certain applications and games (e.g., three-dimensional (3D) games). Although there has been a lot of advancement to increase the processing speed at graphics processors, little has been done in order to reduce the time taken texture fetching operations. In some aspects, textures may be fetched at a graphics processor after the shader processor (SP) reads the instructions to fetch. For example, the shader processor may first check which textures need to be fetched and then a command is used to bring in the textures from the internal memory. Over time, several techniques have been designed to optimize the bandwidth utilization for the generation of textures in graphics processors, as well as for other operations such as block compression, etc. However, bandwidth utilization for the generation of textures still remains an issue within graphics processing. Based on the above, it may be beneficial to increase the memory bandwidth of graphics processors and GPUs. That is, it may be beneficial to increase the memory bandwidth to allow for an increase in computational power at graphics processors and GPUs. Further, it may be beneficial to reduce or optimize the amount of time taken during texture fetch operations at graphics processors and GPUs.

Aspects of the present disclosure may allow for an increase in the memory bandwidth of graphics processors and GPUs. That is, aspects presented herein may increase the memory bandwidth at graphics processors and GPUs in order to allow for an increase in computational power at graphics processors and GPUs. Further, aspects presented herein may reduce or optimize the amount of time taken during texture fetch operations at graphics processors and GPUs. For instance, aspects presented herein may parallelize execution of texture fetch operations by making these operations concurrent with the execution of the other operations at graphics processors. Indeed, aspects presented herein may allow for texture fetch operations to be performed in parallel with other operations. By doing so, aspects presented herein may reduce the amount of latency that is associated with texture fetch operations.

In some instances, aspects presented herein may trigger texture fetching operations to be performed at a different timeline within graphics processors. That is, once the GPU hardware has the information that there are textures that are needed, aspects presented herein may allow for the fetching of these textures immediately, rather than wait for another time period. Also, once the texture fetching process has started, graphics processors may start shading using those textures that have already been fetched. So texture fetching operations can be performed in parallel with other shading operations (e.g., shading operations) in order to reduce the amount of latency to perform each of these operations. Further, this information may already be stored in an internal memory location (e.g., a graphics memory (GMEM) or persistent graphics memory (PGMEM). Aspects presented herein may also fetch textures from an internal memory location (e.g., GMEM or PGMEM). For instance, aspects presented herein may fetch textures from an internal cache instead of fetching directly from system memory. By doing so, aspects presented herein may reduce the amount of time taken to perform texture fetching operations. For example, aspects presented herein may fetch textures from an internal cache rather than fetching directly from system memory, which may reduce the amount of time taken to perform the texture fetching operation by up to 10 times. That is, aspects presented herein may move the source of the texture fetching process from system memory to graphics memory (GMEM) or persistent graphics memory (PGMEM).

Moreover, in some instances, aspects presented herein may utilize certain memory in graphics processors (e.g., GMEM or PGMEM) to store frequently-used textures. This allows textures to be loaded in parallel for upcoming batches while the current workload is being processed (e.g., processed by the shader processor (SP)), thus reducing the amount of latency for texture fetching operations. Also, the workloads submitted (e.g., submitted to the CPU) for each frame may be divided into sections (e.g., buckets) for each render target (e.g., in a frame buffer). Before submitting the command buffer to the GPU, the driver (e.g., graphics driver) can process all of the accumulated textures for all sections (e.g., buckets) and prioritize the resource load to GMEM or PGMEM based on application heuristics. That is, the driver (e.g., graphics driver) may have information on the number and frequency of all the textures used for all the sections (e.g., buckets) in the frame. Further, aspects presented herein may utilize a parallel pipe at the command processor (CP) to load textures concurrently in the GMEM or PGMEM.

Some implementations of aspects herein may allow for increased memory at GPUs (e.g., GMEM or PGMEM), which can be used to store frequently-used textures. Indeed, aspects presented herein may allow for textures to be fetched/read from certain memory (e.g., GMEM or PGMEM) which is faster (e.g., 10 times faster) than fetching/reading from system memory. Also, by loading textures for subsequent batches of workloads while other operations (e.g., shader processing operations) are being performed for the current workload, aspects presented herein may reduce the amount of the time taken to perform texture fetching operations. Thus, aspects presented herein may perform texture fetching operations in parallel with other operations (e.g., shader processing operations). That is, aspects presented herein may provide a mechanism to store textures or texture data simultaneously with other operations, which may allow for an efficient operation of GPUs (e.g., operations that are performed in parallel) to be achieved for high latency operations.

In some aspects, before submitting the command buffer to the GPU, the driver (e.g., graphics driver) may process all of the accumulated textures for a workload. The driver (e.g., graphics driver) may also prioritize the textures which can be copied to certain memory (e.g., GMEM or PGMEM). This prioritization of certain texture may be performed based on application heuristics, such as the frequency of usage by the shader processor. In one example, the workloads submitted (e.g., submitted by the CPU) for each frame may be divided into different sections for different render targets (e.g., at a frame buffer). Also, information may be obtained regarding the number and frequency of the textures used for all the sections (e.g., buckets) in the frame. That is, before submitting the command buffer, the driver (e.g., graphics driver) may obtain information regarding the number and frequency of the textures used for all the sections (e.g., buckets) in the frame.

Additionally, a command processor (CP) (e.g., CP in a GPU) may have a parallel pipe which can interpret a texture copy as being a certain memory operation (e.g., a GMEM or PGMEM operation) and immediately execute this operation. As such, aspects presented herein may propose adding parallel pipe in the command processor which can load the textures concurrently in the GMEM or PGMEM. In this manner, the texture fetch operations may not wait until the shader instructions are processed. The textures utilized by a specific workload may be already present in the GMEM or PGMEM by the time it is utilized by the shader processor (SP). Also, the parallel texture fetch pipe in the CP may keep copying the textures to the GMEM or PGMEM until there is no space left. Further, the driver (e.g., graphics driver) may instruct the shader processors to fetch the textures from GMEM or PGMEM (and not from system memory). The driver (e.g., graphics driver) may also determine the priority of all the textures and its usage by different workloads so that the GMEM or PGMEM can discard the textures that have already been used by previous workload, and thus are no longer needed, or a higher priority workload/surface is obtained. By doing so, this may make room in the GMEM or PGMEM in the event that it reaches its maximum threshold.

Moreover, certain applications that have a high texture fetch latency can benefit from the aforementioned proposals. For instance, certain applications (e.g., 3D games and benchmarks) which have a high texture fetch latency may benefit from adding a parallel pipe in the command processor which can load the textures concurrently in the GMEM or PGMEM. As noted herein, with increasing computational power, certain applications, games and benchmarks may be limited by memory bandwidth of the GPU (e.g., the double data rate (DDR)). Also, aspects presented herein may allow GPUs to include a larger GMEM or PGMEM, which can be used to pre-fetch and store frequently-used textures. Aspects presented herein propose the texture fetch operation to be parallel with other types of operations (e.g., shader processing operations), so that a large amount of the latency associated with texture fetch operations may be reduced.

In some aspects, the driver (e.g., graphics driver) may have the information of all the textures that are going to be used, so it does not have to wait for the shader processor to actually start reading the instructions and then fetch it from system memory. Once the driver (e.g., graphics driver) has the information, it can trigger the fetching of textures from system memory and put it into internal GPU memory (e.g., GMEM or PGMEM). So the driver (e.g., graphics driver) before submitting the command buffer to the GPU can obtain all the accumulated textures (for all the buckets/sections) and prioritize the resource load to the GMEM or PGMEM based on application heuristics. Application heuristics may mean all textures that are most frequently used, as although the GMEM is large, it may still be limited by the amount of textures which can be in the application and what textures are available. As such, aspects presented herein may not fetch all the texture information, but there may be some decisions made based on the frequency of use of the textures. Aspects presented herein may also propose adding a parallel pipe in the command processor which can load the textures concurrently in the GMEM or PGMEM. So the command processor may read the texture instructions that are provided (e.g., provided from the driver).

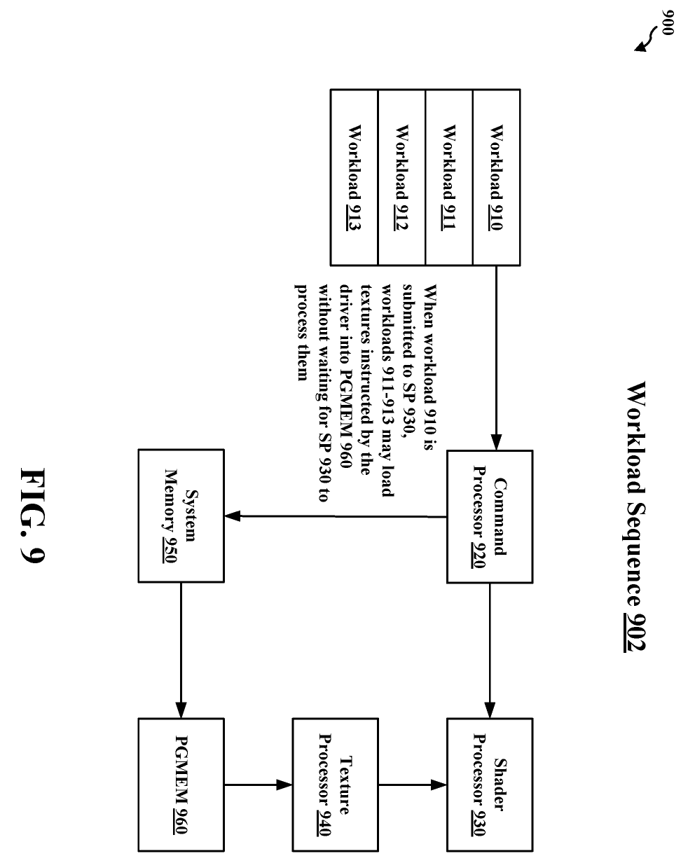

FIG. 9 illustrates diagram 900 including one example of a workload processing sequence. More specifically, diagram 900 depicts a workload execution and texture fetch sequence for graphics processors. As shown in FIG. 9, diagram 900 depicts a workload sequence 902 including a number of workloads (e.g., workload 910, workload 911, workload 912, and workload 913), a command processor 920, a shader processor 930, a texture processor 940, system memory 950, and PGMEM 960 (or GMEM). FIG. 9 shows that texture fetch operation for each of the workloads (e.g., workload 910, workload 911, workload 912, and workload 913) may be performed in parallel with other operations at a GPU. Accordingly, the texture fetch operation may be performed at the same time as other operations, which may result in a reduced latency for all operations. That is, the texture fetch for each of the workloads (e.g., workload 910, workload 911, workload 912, and workload 913) may be performed simultaneous to other operations at the shader processor 930. By doing so, the shader processor 930 may not be idle (i.e., not starve) until the texture data is fetched. For example, as noted in FIG. 9, when workload 910 is submitted to shader processor 930, each of the subsequent workloads (workload 911, workload 912, and workload 913) may load textures (e.g., instructed by the driver) into PGMEM 960 without waiting for shader processor 930 to process the textures. Indeed, the texture fetch may be sent to command processor 920 and then sent to shader processor 930 in a parallel fashion with other operations. As noted in FIG. 9, command processor 920 may communicate with the shader processor 930 and the system memory 950 at the same time, the shader processor 930 may communicate with command processor 920 and the texture processor 940 at the same time, the texture processor 940 may communicate with the shader processor 930 and the PGMEM 960 at the same time, the PGMEM 960 may communicate with the texture processor 940 and the system memory 950 at the same time, and the system memory 950 may communicate with the PGMEM 960 and the command processor 920 at the same time.

As shown in FIG. 9, texture fetching operations may be performed at a different timeline within graphics processors. That is, once the GPU hardware has the information that there are textures that are needed, workload sequence 902 may allow for the fetching of these textures immediately, rather than wait for another time period. Additionally, once the texture fetching process has started in workload sequence 902, graphics processors may start shading using those textures that have already been fetched. So as shown in FIG. 9, workload sequence 902 may allow texture fetching operations to be performed in parallel with other shading operations (e.g., shading operations) in order to reduce the amount of latency to perform each of these operations. Moreover, as shown in FIG. 9, this information may already be stored in an internal memory location (e.g., GMEM or PGMEM 960). Workload sequence 902 may also fetch textures from an internal memory location (e.g., GMEM or PGMEM 960). For instance, as shown in FIG. 9, workload sequence 902 may fetch textures from an internal cache instead of fetching directly from system memory. By doing so, workload sequence 902 may reduce the amount of time taken to perform texture fetching operations. For example, as shown in FIG. 9, workload sequence 902 may fetch textures from an internal cache rather (e.g., PGMEM 960) than fetching directly from system memory 950, which may reduce the amount of time taken to perform the texture fetching operations (e.g., by up to 10 times). That is, workload sequence 902 may move the source of the texture fetching process from system memory 950 to GMEM or PGMEM 960.

Additionally, as shown in FIG. 9, workload sequence 902 may utilize certain memory in graphics processors (e.g., GMEM or PGMEM 960) to store frequently-used textures. This allows textures to be loaded in parallel for upcoming batches while the current workload is being processed (e.g., processed by the shader processor 930), thus reducing the amount of latency for texture fetching operations. Further, workload sequence 902 may allow the workloads submitted for each frame to be divided into sections (e.g., buckets) for each render target (e.g., in a frame buffer). As shown in FIG. 9, before submitting the command buffer to the GPU, the driver (e.g., graphics driver) can process all of the accumulated textures for all sections (e.g., buckets) and prioritize the resource load to GMEM or PGMEM 960 based on application heuristics. Workload sequence 902 allows a driver (e.g., graphics driver) to have information on the number and frequency of all the textures used for all the sections (e.g., buckets) in the frame. Further, as shown in FIG. 9, workload sequence 902 may utilize a parallel pipe at the command processor 920 to load textures concurrently in the GMEM or PGMEM 960. As shown in FIG. 9, the parallel pipe from the command processor to system memory 950 may allow the texture data to be loaded concurrently in the GMEM or PGMEM 960. Also, workload sequence 902 may allow for increased memory at GPUs (e.g., GMEM or PGMEM 960), which can be used to store frequently-used textures. Indeed, workload sequence 902 may allow for textures to be fetched/read from certain memory (e.g., GMEM or PGMEM 960) which is faster (e.g., 10 times faster) than fetching/reading from system memory 950. Also, by loading textures for subsequent batches of workloads while other operations (e.g., shader processing operations) are being performed for the current workload, workload sequence 902 may reduce the amount of the time taken to perform texture fetching operations. Therefore, workload sequence 902 may perform texture fetching operations in parallel with other operations (e.g., shader processing operations). That is, workload sequence 902 may provide a mechanism to store textures or texture data simultaneously with other operations, which may allow for an efficient operation of GPUs (e.g., operations that are performed in parallel) to be achieved for high latency operations.

As shown in FIG. 9, a driver (e.g., graphics driver) may have the information of all the textures that are going to be used, so it may not have to wait for the shader processor 930 to actually start reading the instructions and then fetch it from system memory 950. Once the driver (e.g., graphics driver) has the information, it can trigger the fetching of textures from system memory 950 and put it into internal GPU memory (e.g., GMEM or PGMEM 960). As shown in FIG. 9, before submitting the command buffer to the GPU, the driver (e.g., graphics driver) can obtain all the accumulated textures and prioritize the resource load to the GMEM or PGMEM 960 based on application heuristics (i.e., textures that are most frequently used). As such, workload sequence 902 may not fetch all the texture information, but there may be some decisions that are made based on the frequency of use of the textures. Workload sequence 902 may also add a parallel pipe in the command processor which can load the textures concurrently in the GMEM or PGMEM 960 (e.g., a pipe from command processor 920 to system memory 950). So the command processor 920 may read the texture instructions that are provided (e.g., provided from the driver) with a reduced latency.

Additionally, as shown in FIG. 9, loading resources for the second and subsequent workloads (workload 911, workload 912, and workload 913) to GMEM while the first workload is being executed by the GPU may allow operations to be performed in parallel, and thus reduce the amount of latency attributed to texture fetch operations. As shown in FIG. 9, aspects presented herein may be hardware based (e.g., graphics processor hardware based). The driver (e.g., graphics driver) may maintain and submit a list of all resources which are utilized by the workloads 910/911/912/913 in the submission. Once the submission (for all workloads 910/911/912/913) reaches the GPU, the hardware may start fetching textures for the current workload 910, as well as subsequent workloads 911/912/913. Aspects presented herein may have a considerable performance improvement for certain benchmarks (e.g., 3D mark benchmarks) and any application/game that uses multiple high-resolution textures. As indicated herein, while textures may be fetched after a shader processor reads the instructions to fetch, aspects presented herein may allow a driver (e.g., graphics driver) to instruct to fetch the textures and store in GMEM or PGMEM 960, so that once the instructions are needed, they are already available in the internal memory. As such, these operations may be performed in parallel to the shader execution of previous workloads, thus resulting in a reduced latency associated with texture fetch operations.

As depicted in FIG. 9, workload sequence 902 may be both software-based and/or hardware-based, which may allow for concurrency in texture fetch operations utilizing a new hardware pipe and large GPU memory (e.g., GMEM or PGMEM 960). This may reduce the amount of time utilized for intensive operations for many applications (e.g., 3D games). Aspects presented herein may utilize a large on-chip memory space (PGMEM 960 or otherwise) and a hardware pipe (e.g., pipe from command processor 920 to system memory 950). This may reduce the time utilized for intensive operations for many applications (e.g., 3D games). With the addition of PGMEM 960 and an independent hardware pipe for texture fetching (e.g., pipe from command processor 920 to system memory 950), concurrency in texture fetch operations may be achieved by hardware based on instructions from the software.

As shown in FIG. 9, command processor 920 may obtain an indication of a set of graphics workloads associated with the graphics processing. Further, shader processor 930 may execute at least one first graphics workload (e.g., workload 910) in the set of graphics workloads, where the at least one first graphics workload is associated with first data. Also, PGMEM 960 may store, based on the execution of the at least one first graphics workload, second data that is associated with at least one second graphics workload (e.g., workload 911) in the set of graphics workloads. Aspects presented herein may also determine whether a storage capacity of the memory at the graphics processor (e.g., PGMEM 960) is less than or equal to a storage threshold. Based on the storage capacity of the memory (e.g., PGMEM 960) being less than the storage threshold, aspects presented herein may store, in the memory (e.g., PGMEM 960), third data that is associated with at least one third graphics workload (e.g., workload 912 or workload 913) in the set of graphics workloads. Based on the storage capacity of the memory (e.g., PGMEM 960) being equal to the storage threshold, aspects herein may discard, from the memory (e.g., PGMEM 960), previous data that is associated with at least one previous graphics workload (e.g., a workload that is prior to workload 910). After the discarding, aspects presented herein may store, in the memory (e.g., PGMEM 960), third data that is associated with at least one third graphics workload (e.g., workload 912 or workload 913) in the set of graphics workloads. Additionally, after the storage of the second data, aspects presented herein may retrieve the second data that is associated with the at least one second graphics workload (e.g., workload 911). Based on the retrieval, aspects presented herein may output the second data that is associated with the at least one second graphics workload (e.g., workload 911).

Aspects of the present disclosure may include a number of benefits or advantages. For instance, aspects presented herein may allow for an increase in the memory bandwidth of graphics processors and GPUs. That is, aspects presented herein may increase the memory bandwidth at graphics processors and GPUs in order to allow for an increase in computational power at graphics processors and GPUs. Further, aspects presented herein may reduce or optimize the amount of time taken during texture fetch operations at graphics processors and GPUs. For instance, aspects presented herein may parallelize execution of texture fetch operations by making these operations concurrent with the execution of the other operations at graphics processors. Indeed, aspects presented herein may allow for texture fetch operations to be performed in parallel with other operations. By doing so, aspects presented herein may reduce the amount of latency that is associated with texture fetch operations.

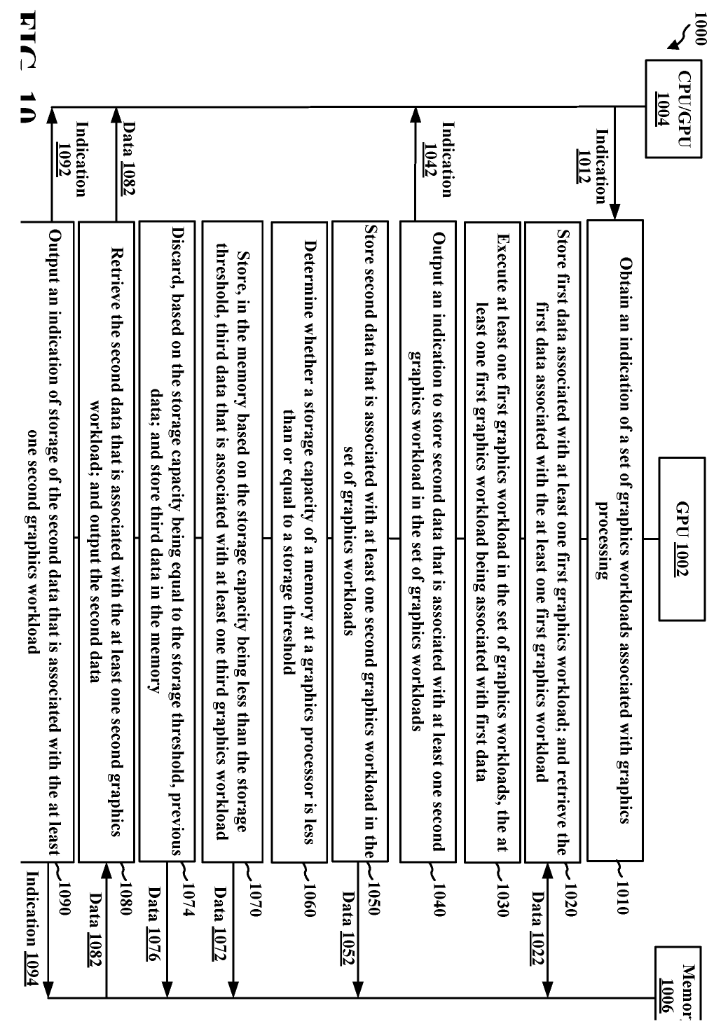

FIG. 10 is a communication flow diagram 1000 of graphics processing in accordance with one or more techniques of this disclosure. As shown in FIG. 10, diagram 1000 includes example communications between GPU 1002 (e.g., a GPU, a cache at a GPU, a GPU component, another graphics processor, a CPU, a CPU component, or another central processor), CPU/GPU 1004 (e.g., a GPU, a cache at a GPU, a GPU component, another graphics processor, a CPU, a CPU component, or another central processor), and memory 1006 (e.g., a memory, a cache, a system memory, a graphics memory, a memory or cache at a CPU, or a memory or cache at a GPU), in accordance with one or more techniques of this disclosure.

At 1010, GPU 1002 may obtain an indication of a set of graphics workloads associated with the graphics processing. For example, GPU 1002 may obtain indication 1012 from CPU/GPU 1004.

At 1020, GPU 1002 may store the first data associated with the at least one first graphics workload in the set of graphics workloads; and retrieve, prior to the execution of the at least one first graphics workload, the first data associated with the at least one first graphics workload. For example, GPU 1002 may store data 1022 in memory 1006; and retrieve data 1022 from memory 1006.

At 1030, GPU 1002 may execute at least one first graphics workload in the set of graphics workloads, where the at least one first graphics workload is associated with first data. In some aspects, the first data may include at least one of first texture data, a first texture, or a first texture resource, and the second data may include at least one of second texture data, a second texture, or a second texture resource.

At 1040, GPU 1002 may output, prior to storage of second data, an indication to store the second data that is associated with the at least one second graphics workload. For example, GPU 1002 may output indication 1042 to CPU/GPU 1004. In some aspects, outputting the indication to store the second data may comprise: outputting, by a graphics driver at a graphics processor, the indication to store the second data.

At 1050, GPU 1002 may store, based on the execution of the at least one first graphics workload, second data that is associated with at least one second graphics workload in the set of graphics workloads. For example, GPU 1002 may store data 1052 in memory 1006. In some aspects, storing the at least one second graphics workload may comprise storing the at least one second graphics workload in a memory at a graphics processor. Additionally, storing the second data that is associated with the at least one second graphics workload may comprise: storing the second data that is associated with the at least one second graphics workload simultaneously as the execution of the at least one first graphics workload. Also, the at least one second graphics workload may be subsequent to the at least one first graphics workload in a workload order of a graphics pipeline at a graphics processor.

At 1060, GPU 1002 may determine whether a storage capacity of memory at a graphics processor is less than or equal to a storage threshold. In some aspects, the memory at the graphics processor may be a graphics memory (GMEM) or a persistent GMEM (PGMEM).

At 1070, GPU 1002 may store, in the memory based on the storage capacity of the memory being less than the storage threshold, third data that is associated with at least one third graphics workload in the set of graphics workloads. For example, GPU 1002 may store data 1072 in memory 1006. In some aspects, the at least one third graphics workload may be subsequent to the at least one second graphics workload in a workload order of a graphics pipeline at the graphics processor.

At 1074, GPU 1002 may discard, from the memory based on the storage capacity of the memory being equal to the storage threshold, previous data that is associated with at least one previous graphics workload; and store, in the memory, third data that is associated with at least one third graphics workload in the set of graphics workloads. For example, GPU 1002 may store data 1076 in memory 1006. In some aspects, the at least one first graphics workload and the at least one second graphics workload may be subsequent to the at least one previous graphics workload in a workload order of a graphics pipeline at the graphics processor. Also, the at least one third graphics workload may be subsequent to the at least one second graphics workload in the workload order. Further, the previous data may include at least one of previous texture data, a previous texture, or a previous texture resource. Also, the third data may include at least one of third texture data, a third texture, or a third texture resource.

At 1080, GPU 1002 may retrieve, after storage of the second data, the second data that is associated with the at least one second graphics workload; and output, based on the retrieval, the second data that is associated with the at least one second graphics workload. For example, GPU 1002 may retrieve data 1082 from memory 1006. In some aspects, outputting the second data that is associated with the at least one second graphics workload may comprise: outputting, to a shader processor (SP) at a graphics processor, the second data that is associated with the at least one second graphics workload.

At 1090, GPU 1002 may output an indication of storage of the second data that is associated with the at least one second graphics workload. In some aspects, outputting the indication of the storage of the second data that is associated with the at least one second graphics workload may comprise transmitting the indication of the storage of the second data that is associated with the at least one second graphics workload. For example, GPU 1002 may transmit indication 1092 to CPU/GPU 1004. Also, outputting the indication of the storage of the second data that is associated with the at least one second graphics workload may comprise storing the indication of the storage of the second data that is associated with the at least one second graphics workload. For example, GPU 1002 may store indication 1094 in memory 1006.

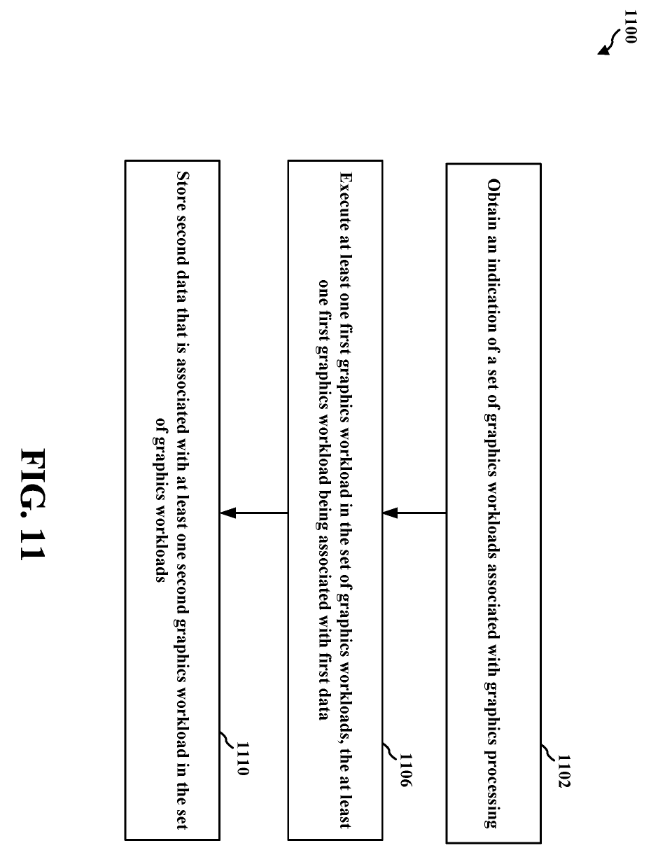

FIG. 11 is a flowchart 1100 of an example method of graphics processing in accordance with one or more techniques of this disclosure. The method may be performed by a GPU (e.g., a GPU, a cache at a GPU, a GPU component, another graphics processor, a CPU, a CPU component, or another central processor), a CPU (e.g., a CPU, a cache at a CPU, a CPU component, another central processor, a GPU, a GPU component, or another graphics processor), a display driver integrated circuit (DDIC), an apparatus for data or graphics processing, a wireless communication device, and/or any apparatus that may perform data or graphics processing as used in connection with the examples of FIGS. 1-10.

At 1102, the GPU may obtain an indication of a set of graphics workloads associated with the graphics processing, as described in connection with the examples in FIGS. 1-10. For example, as described in 1010 of FIG. 10, GPU 1002 may obtain an indication of a set of graphics workloads associated with the graphics processing. Further, step 1102 may be performed by processing unit 120 in FIG. 1.

At 1106, the GPU may execute at least one first graphics workload in the set of graphics workloads, where the at least one first graphics workload is associated with first data, as described in connection with the examples in FIGS. 1-10. For example, as described in 1030 of FIG. 10, GPU 1002 may execute at least one first graphics workload in the set of graphics workloads, where the at least one first graphics workload is associated with first data. Further, step 1106 may be performed by processing unit 120 in FIG. 1. In some aspects, the first data may include at least one of first texture data, a first texture, or a first texture resource, and the second data may include at least one of second texture data, a second texture, or a second texture resource.

At 1110, the GPU may store, based on the execution of the at least one first graphics workload, second data that is associated with at least one second graphics workload in the set of graphics workloads, as described in connection with the examples in FIGS. 1-10. For example, as described in 1050 of FIG. 10, GPU 1002 may store, based on the execution of the at least one first graphics workload, second data that is associated with at least one second graphics workload in the set of graphics workloads. Further, step 1110 may be performed by processing unit 120 in FIG. 1. In some aspects, storing the at least one second graphics workload may comprise storing the at least one second graphics workload in a memory at a graphics processor. Additionally, storing the second data that is associated with the at least one second graphics workload may comprise: storing the second data that is associated with the at least one second graphics workload simultaneously as the execution of the at least one first graphics workload. Also, the at least one second graphics workload may be subsequent to the at least one first graphics workload in a workload order of a graphics pipeline at a graphics processor.

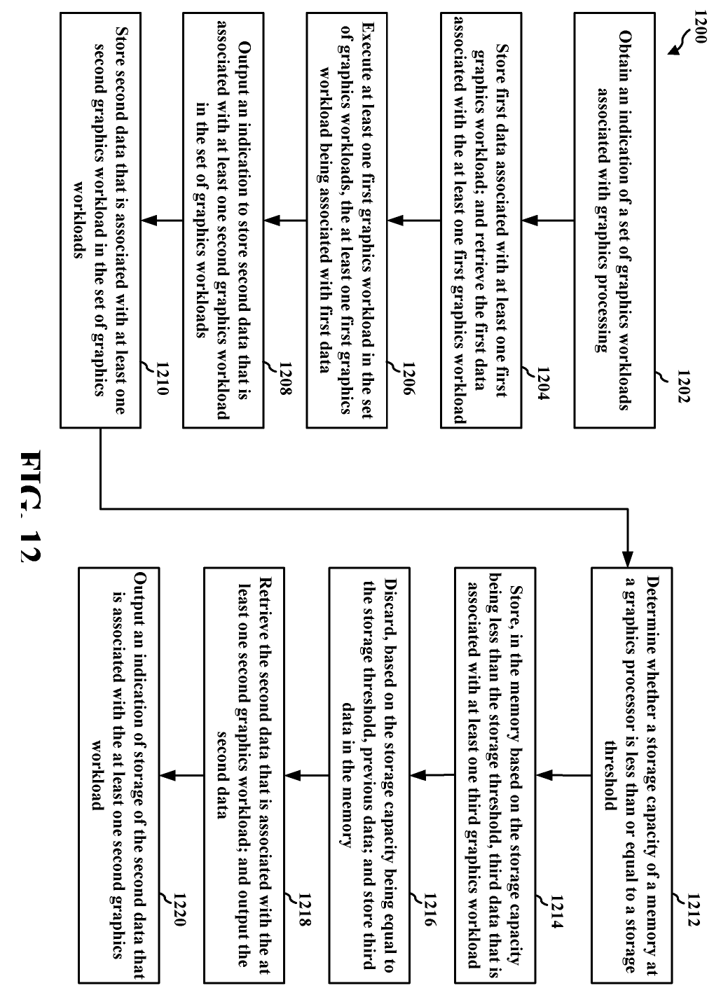

FIG. 12 is a flowchart 1200 of an example method of graphics processing in accordance with one or more techniques of this disclosure. The method may be performed by a GPU (e.g., a GPU, a cache at a GPU, a GPU component, another graphics processor, a CPU, a CPU component, or another central processor), a CPU (e.g., a CPU, a cache at a CPU, a CPU component, another central processor, a GPU, a GPU component, or another graphics processor), a display driver integrated circuit (DDIC), an apparatus for data or graphics processing, a wireless communication device, and/or any apparatus that may perform data or graphics processing as used in connection with the examples of FIGS. 1-10.

At 1202, the GPU may obtain an indication of a set of graphics workloads associated with the graphics processing, as described in connection with the examples in FIGS. 1-10. For example, as described in 1010 of FIG. 10, GPU 1002 may obtain an indication of a set of graphics workloads associated with the graphics processing. Further, step 1202 may be performed by processing unit 120 in FIG. 1.

At 1204, the GPU may store the first data associated with the at least one first graphics workload in the set of graphics workloads; and retrieve, prior to the execution of the at least one first graphics workload, the first data associated with the at least one first graphics workload, as described in connection with the examples in FIGS. 1-10. For example, as described in 1020 of FIG. 10, GPU 1002 may store the first data associated with the at least one first graphics workload in the set of graphics workloads; and retrieve, prior to the execution of the at least one first graphics workload, the first data associated with the at least one first graphics workload. Further, step 1204 may be performed by processing unit 120 in FIG. 1.

At 1206, the GPU may execute at least one first graphics workload in the set of graphics workloads, where the at least one first graphics workload is associated with first data, as described in connection with the examples in FIGS. 1-10. For example, as described in 1030 of FIG. 10, GPU 1002 may execute at least one first graphics workload in the set of graphics workloads, where the at least one first graphics workload is associated with first data. Further, step 1206 may be performed by processing unit 120 in FIG. 1. In some aspects, the first data may include at least one of first texture data, a first texture, or a first texture resource, and the second data may include at least one of second texture data, a second texture, or a second texture resource.

At 1208, the GPU may output, prior to storage of second data, an indication to store the second data that is associated with the at least one second graphics workload, as described in connection with the examples in FIGS. 1-10. For example, as described in 1040 of FIG. 10, GPU 1002 may output, prior to storage of second data, an indication to store the second data that is associated with the at least one second graphics workload. Further, step 1208 may be performed by processing unit 120 in FIG. 1. In some aspects, outputting the indication to store the second data may comprise: outputting, by a graphics driver at a graphics processor, the indication to store the second data.

At 1210, the GPU may store, based on the execution of the at least one first graphics workload, second data that is associated with at least one second graphics workload in the set of graphics workloads, as described in connection with the examples in FIGS. 1-10. For example, as described in 1050 of FIG. 10, GPU 1002 may store, based on the execution of the at least one first graphics workload, second data that is associated with at least one second graphics workload in the set of graphics workloads. Further, step 1210 may be performed by processing unit 120 in FIG. 1. In some aspects, storing the at least one second graphics workload may comprise storing the at least one second graphics workload in a memory at a graphics processor. Additionally, storing the second data that is associated with the at least one second graphics workload may comprise: storing the second data that is associated with the at least one second graphics workload simultaneously as the execution of the at least one first graphics workload. Also, the at least one second graphics workload may be subsequent to the at least one first graphics workload in a workload order of a graphics pipeline at a graphics processor.

At 1212, the GPU may determine whether a storage capacity of memory at a graphics processor is less than or equal to a storage threshold, as described in connection with the examples in FIGS. 1-10. For example, as described in 1060 of FIG. 10, GPU 1002 may determine whether a storage capacity of memory at a graphics processor is less than or equal to a storage threshold. Further, step 1212 may be performed by processing unit 120 in FIG. 1. In some aspects, the memory at the graphics processor may be a graphics memory (GMEM) or a persistent GMEM (PGMEM).

At 1214, the GPU may store, in the memory based on the storage capacity of the memory being less than the storage threshold, third data that is associated with at least one third graphics workload in the set of graphics workloads, as described in connection with the examples in FIGS. 1-10. For example, as described in 1070 of FIG. 10, GPU 1002 may store, in the memory based on the storage capacity of the memory being less than the storage threshold, third data that is associated with at least one third graphics workload in the set of graphics workloads. Further, step 1214 may be performed by processing unit 120 in FIG. 1. In some aspects, the at least one third graphics workload may be subsequent to the at least one second graphics workload in a workload order of a graphics pipeline at the graphics processor.

At 1216, the GPU may discard, from the memory based on the storage capacity of the memory being equal to the storage threshold, previous data that is associated with at least one previous graphics workload; and store, in the memory, third data that is associated with at least one third graphics workload in the set of graphics workloads, as described in connection with the examples in FIGS. 1-10. For example, as described in 1074 of FIG. 10, GPU 1002 may discard, from the memory based on the storage capacity of the memory being equal to the storage threshold, previous data that is associated with at least one previous graphics workload; and store, in the memory, third data that is associated with at least one third graphics workload in the set of graphics workloads. Further, step 1216 may be performed by processing unit 120 in FIG. 1. In some aspects, the at least one first graphics workload and the at least one second graphics workload may be subsequent to the at least one previous graphics workload in a workload order of a graphics pipeline at the graphics processor. Also, the at least one third graphics workload may be subsequent to the at least one second graphics workload in the workload order. Further, the previous data may include at least one of previous texture data, a previous texture, or a previous texture resource. Also, the third data may include at least one of third texture data, a third texture, or a third texture resource.

At 1218, the GPU may retrieve, after storage of the second data, the second data that is associated with the at least one second graphics workload; and output, based on the retrieval, the second data that is associated with the at least one second graphics workload, as described in connection with the examples in FIGS. 1-10. For example, as described in 1080 of FIG. 10, GPU 1002 may retrieve, after storage of the second data, the second data that is associated with the at least one second graphics workload; and output, based on the retrieval, the second data that is associated with the at least one second graphics workload. Further, step 1218 may be performed by processing unit 120 in FIG. 1. In some aspects, outputting the second data that is associated with the at least one second graphics workload may comprise: outputting, to a shader processor (SP) at a graphics processor, the second data that is associated with the at least one second graphics workload.

At 1220, the GPU may output an indication of storage of the second data that is associated with the at least one second graphics workload, as described in connection with the examples in FIGS. 1-10. For example, as described in 1090 of FIG. 10, GPU 1002 may output an indication of storage of the second data that is associated with the at least one second graphics workload. Further, step 1220 may be performed by processing unit 120 in FIG. 1. In some aspects, outputting the indication of the storage of the second data that is associated with the at least one second graphics workload may comprise transmitting the indication of the storage of the second data that is associated with the at least one second graphics workload. For example, GPU 1002 may transmit indication 1092 to CPU/GPU 1004. Also, outputting the indication of the storage of the second data that is associated with the at least one second graphics workload may comprise storing the indication of the storage of the second data that is associated with the at least one second graphics workload. For example, GPU 1002 may store indication 1094 in memory 1006.

In configurations, a method or an apparatus for data or graphics processing is provided. The apparatus may be a GPU (or other graphics processor), a CPU (or other central processor), a DDIC, an apparatus for graphics processing, and/or some other processor that may perform data or graphics processing. In aspects, the apparatus may be the processing unit 120 within the device 104, or may be some other hardware within the device 104 or another device. The apparatus, e.g., processing unit 120, may include means for obtaining an indication of a set of graphics workloads associated with the graphics processing. The apparatus, e.g., processing unit 120, may also include means for executing at least one first graphics workload in the set of graphics workloads, where the at least one first graphics workload is associated with first data. The apparatus, e.g., processing unit 120, may also include means for storing, based on the execution of the at least one first graphics workload, second data that is associated with at least one second graphics workload in the set of graphics workloads. The apparatus, e.g., processing unit 120, may also include means for determining whether a storage capacity of the memory at the graphics processor is less than or equal to a storage threshold. The apparatus, e.g., processing unit 120, may also include means for storing, in the memory based on the storage capacity of the memory being less than the storage threshold, third data that is associated with at least one third graphics workload in the set of graphics workloads. The apparatus, e.g., processing unit 120, may also include means for discarding, from the memory based on the storage capacity of the memory being equal to the storage threshold, previous data that is associated with at least one previous graphics workload; and means for storing, in the memory, third data that is associated with at least one third graphics workload in the set of graphics workloads. The apparatus, e.g., processing unit 120, may also include means for storing the first data associated with the at least one first graphics workload in the set of graphics workloads; and means for retrieving, prior to the execution of the at least one first graphics workload, the first data associated with the at least one first graphics workload. The apparatus, e.g., processing unit 120, may also include means for outputting, prior to storage of the second data, an indication to store the second data that is associated with the at least one second graphics workload. The apparatus, e.g., processing unit 120, may also include means for retrieving, after storage of the second data, the second data that is associated with the at least one second graphics workload; and means for outputting, based on the retrieval, the second data that is associated with the at least one second graphics workload. The apparatus, e.g., processing unit 120, may also include means for outputting an indication of storage of the second data that is associated with the at least one second graphics workload.

The subject matter described herein may be implemented to realize one or more benefits or advantages. For instance, the described graphics processing techniques may be used by a GPU, a CPU, a central processor, or some other processor that may perform graphics processing to implement the concurrent texture fetch techniques described herein. This may also be accomplished at a low cost compared to other graphics processing techniques. Moreover, the graphics processing techniques herein may improve or speed up graphics processing or execution. Further, the graphics processing techniques herein may improve resource or data utilization and/or resource efficiency. Additionally, aspects of the present disclosure may utilize concurrent texture fetch techniques in order to improve memory bandwidth efficiency and/or increase processing speed at a CPU, a GPU, or a DPU.

It is understood that the specific order or hierarchy of blocks in the processes / flowcharts disclosed is an illustration of example approaches. Based upon design preferences, it is understood that the specific order or hierarchy of blocks in the processes / flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is an apparatus for graphics processing, including at least one memory and at least one processor coupled to the at least one memory and, based at least in part on information stored in the at least one memory, the at least one processor, individually or in any combination, is configured to: obtain an indication of a set of graphics workloads associated with the graphics processing; execute at least one first graphics workload in the set of graphics workloads, wherein the at least one first graphics workload is associated with first data; and store, based on the execution of the at least one first graphics workload, second data that is associated with at least one second graphics workload in the set of graphics workloads.

Aspect 2 is the apparatus of aspect 1, wherein to store the at least one second graphics workload, the at least one processor, individually or in any combination, is configured to: store the at least one second graphics workload in a memory at a graphics processor, and wherein the at least one processor, individually or in any combination, is further configured to: determine whether a storage capacity of the memory at the graphics processor is less than or equal to a storage threshold.

Aspect 3 is the apparatus of aspect 2, wherein the at least one processor, individually or in any combination, is further configured to: store, in the memory based on the storage capacity of the memory being less than the storage threshold, third data that is associated with at least one third graphics workload in the set of graphics workloads.

Aspect 4 is the apparatus of aspect 3, wherein the at least one third graphics workload is subsequent to the at least one second graphics workload in a workload order of a graphics pipeline at the graphics processor.

Aspect 5 is the apparatus of aspect 2, wherein the at least one processor, individually or in any combination, is further configured to: discard, from the memory based on the storage capacity of the memory being equal to the storage threshold, previous data that is associated with at least one previous graphics workload; and store, in the memory, third data that is associated with at least one third graphics workload in the set of graphics workloads.

Aspect 6 is the apparatus of aspect 5, wherein the at least one first graphics workload and the at least one second graphics workload are subsequent to the at least one previous graphics workload in a workload order of a graphics pipeline at the graphics processor, and wherein the at least one third graphics workload is subsequent to the at least one second graphics workload in the workload order.

Aspect 7 is the apparatus of any of aspects 5 to 6, wherein the previous data includes at least one of previous texture data, a previous texture, or a previous texture resource, and wherein the third data includes at least one of third texture data, a third texture, or a third texture resource.

Aspect 8 is the apparatus of any of aspects 2 to 7, wherein the memory at the graphics processor is a graphics memory (GMEM) or a persistent GMEM (PGMEM).

Aspect 9 is the apparatus of any of aspects 1 to 8, wherein the at least one processor, individually or in any combination, is further configured to: store the first data associated with the at least one first graphics workload in the set of graphics workloads; and retrieve, prior to the execution of the at least one first graphics workload, the first data associated with the at least one first graphics workload.

Aspect 10 is the apparatus of any of aspects 1 to 9, wherein the at least one processor, individually or in any combination, is further configured to: output, prior to storage of the second data, an indication to store the second data that is associated with the at least one second graphics workload.

Aspect 11 is the apparatus of aspect 10, wherein to output the indication to store the second data, the at least one processor, individually or in any combination, is configured to: output, by a graphics driver at a graphics processor, the indication to store the second data.

Aspect 12 is the apparatus of any of aspects 1 to 11, wherein to store the second data that is associated with the at least one second graphics workload, the at least one processor, individually or in any combination, is configured to: store the second data that is associated with the at least one second graphics workload simultaneously as the execution of the at least one first graphics workload.

Aspect 13 is the apparatus of any of aspects 1 to 12, wherein the first data includes at least one of first texture data, a first texture, or a first texture resource, and wherein the second data includes at least one of second texture data, a second texture, or a second texture resource.

Aspect 14 is the apparatus of any of aspects 1 to 13, wherein the at least one second graphics workload is subsequent to the at least one first graphics workload in a workload order of a graphics pipeline at a graphics processor.

Aspect 15 is the apparatus of any of aspects 1 to 14, wherein the at least one processor, individually or in any combination, is further configured to: retrieve, after storage of the second data, the second data that is associated with the at least one second graphics workload; and output, based on the retrieval, the second data that is associated with the at least one second graphics workload.

Aspect 16 is the apparatus of aspect 15, wherein to output the second data that is associated with the at least one second graphics workload, the at least one processor, individually or in any combination, is configured to: output, to a shader processor (SP) at a graphics processor, the second data that is associated with the at least one second graphics workload.

Aspect 17 is the apparatus of any of aspects 1 to 16, wherein the at least one processor, individually or in any combination, is further configured to: output an indication of storage of the second data that is associated with the at least one second graphics workload.

Aspect 18 is the apparatus of aspect 17, wherein to output the indication of the storage of the second data that is associated with the at least one second graphics workload, the at least one processor, individually or in any combination, is configured to: transmit the indication of the storage of the second data that is associated with the at least one second graphics workload; or store the indication of the storage of the second data that is associated with the at least one second graphics workload.

Aspect 19 is the apparatus of aspect 18, further including (i.e., comprising) at least one of an antenna or a transceiver coupled to the at least one processor, wherein to transmit the indication of the storage of the second data that is associated with the at least one second graphics workload, the at least one processor, individually or in any combination, is configured to: transmit, via at least one of an antenna or a transceiver, the indication of the storage of the second data that is associated with the at least one second graphics workload.

Aspect 20 is the apparatus of any of aspects 1 to 19, wherein the apparatus is a wireless communication device.

Aspect 21 is a method of graphics processing for implementing any of aspects 1 to 20.

Aspect 22 is an apparatus for graphics processing including means for implementing any of aspects 1 to 20.

Aspect 23 is a computer-readable medium (e.g., a non-transitory computer-readable medium) storing computer executable code (e.g., code for graphics processing), the code when executed by at least one processor causes the at least one processor to implement any of aspects 1 to 20.

What is claimed is:

1. An apparatus for graphics processing, comprising:
a first memory; and
a processor coupled to the first memory and, based at least in part on information stored in the first memory, the processor is configured to:
obtain an indication of a set of graphics workloads associated with the graphics processing;
execute a first graphics workload in the set of graphics workloads, wherein the first graphics workload is associated with first data; and
store, based on the execution of the first graphics workload, second data that is associated with a second graphics workload in the set of graphics workloads.

2. The apparatus of claim 1, wherein to store the second graphics workload, the processor is configured to: store the second graphics workload in a memory at a graphics processor, and wherein the processor is further configured to:
determine whether a storage capacity of the memory at the graphics processor is less than or equal to a storage threshold.

3. The apparatus of claim 2, wherein the processor is further configured to:
store, in the memory based on the storage capacity of the memory being less than the storage threshold, third data that is associated with a third graphics workload in the set of graphics workloads.

4. The apparatus of claim 3, wherein the third graphics workload is subsequent to the second graphics workload in a workload order of a graphics pipeline at the graphics processor.

5. The apparatus of claim 2, wherein the processor is further configured to:
discard, from the memory based on the storage capacity of the memory being equal to the storage threshold, previous data that is associated with a previous graphics workload; and
store, in the memory, third data that is associated with a third graphics workload in the set of graphics workloads.

6. The apparatus of claim 5, wherein the first graphics workload and the second graphics workload are subsequent to the previous graphics workload in a workload order of a graphics pipeline at the graphics processor, and
wherein the third graphics workload is subsequent to the second graphics workload in the workload order.

7. The apparatus of claim 5, wherein the previous data includes at least one of previous texture data, a previous texture, or a previous texture resource, and
wherein the third data includes at least one of third texture data, a third texture, or a third texture resource.

8. The apparatus of claim 2, wherein the memory at the graphics processor is a graphics memory (GMEM) or a persistent GMEM (PGMEM).

9. The apparatus of claim 1, wherein the processor is further configured to:
store the first data associated with the first graphics workload in the set of graphics workloads; and
retrieve, prior to the execution of the first graphics workload, the first data associated with the first graphics workload.

10. The apparatus of claim 1, wherein the processor is further configured to:
output, prior to storage of the second data, an indication to store the second data that is associated with the second graphics workload.

11. The apparatus of claim 10, wherein to output the indication to store the second data, the processor is configured to: output, by a graphics driver at a graphics processor, the indication to store the second data.

12. The apparatus of claim 1, wherein to store the second data that is associated with the second graphics workload, the processor is configured to: store the second data that is associated with the second graphics workload simultaneously as the execution of the first graphics workload.

13. The apparatus of claim 1, wherein the first data includes at least one of first texture data, a first texture, or a first texture resource, and wherein the second data includes at least one of second texture data, a second texture, or a second texture resource.

14. The apparatus of claim 1, wherein the second graphics workload is subsequent to the first graphics workload in a workload order of a graphics pipeline at a graphics processor.

15. The apparatus of claim 1, wherein the processor is further configured to:
retrieve, after storage of the second data, the second data that is associated with the second graphics workload; and
output, based on the retrieval, the second data that is associated with the second graphics workload.

16. The apparatus of claim 15, wherein to output the second data that is associated with the second graphics workload, the processor is configured to: output, to a shader processor (SP) at a graphics processor, the second data that is associated with the second graphics workload.

17. The apparatus of claim 1, wherein the processor is further configured to:
output an indication of storage of the second data that is associated with the second graphics workload.

18. The apparatus of claim 17, wherein to output the indication of the storage of the second data that is associated with the second graphics workload, the processor is configured to:
transmit the indication of the storage of the second data that is associated with the second graphics workload; or
store the indication of the storage of the second data that is associated with the second graphics workload.

19. A method of graphics processing, comprising:
obtaining an indication of a set of graphics workloads associated with the graphics processing;
executing a first graphics workload in the set of graphics workloads, wherein the first graphics workload is associated with first data; and
storing, based on the execution of the first graphics workload, second data that is associated with a second graphics workload in the set of graphics workloads.

20. A computer-readable medium storing computer executable code for graphics processing, the code when executed by a processor causes the processor to:
obtain an indication of a set of graphics workloads associated with the graphics processing;
execute a first graphics workload in the set of graphics workloads, wherein the first graphics workload is associated with first data; and
store, based on the execution of the first graphics workload, second data that is associated with a second graphics workload in the set of graphics workloads.
